(19) United States
(12) Patent Application Publication
(10) Pub. No.: US 2005/0091150 A1
(43) Pub. Date: Apr. 28, 2005

(54) Combination debt/equity units

(76) Inventor: Andrew K. Woeber, New York, NY (US)

Correspondence Address: KIRKPATRICK & LOCKHART NICHOLSON GRAHAM LLP, 535 SMITHFIELD STREET, PITTSBURGH, PA, 15222, US

(21) Appl. No.: 10/811,247

(22) Filed: Mar. 26, 2004

Related U.S. Application Data
(63) Continuation-in-part of application No. 10/694,669, filed on Oct. 27, 2003, now abandoned.

(51) Int. Cl. G06F 17/60

(52) U.S. Cl. 705/38; 705/37

(57) ABSTRACT

In certain embodiments, a unit capable of being listed on at least one exchange is provided. The unit includes an equity component and a debt component, the equity component being detachable from the debt component; the unit having a significant yield; the equity component comprised of common stock; the debt component having a fixed maturity period of approximately 30 years or less; and, the debt component being puttable back to an issuer after expiration of a certain put period. In other embodiments, capital structures involving the units and methods for arranging for issuance of the units are also provided.

### CROSS-REFERENCE TO RELATED APPLICATION

The present application is a continuation-in-part of U.S. patent application Ser. No. 10/694,669, filed Oct. 27, 2003.

### BACKGROUND

A variety of instruments, securities and capital structures that generate significant yields is available to issuers and investors. Such instruments, securities and capital structures may provide yields through a combination of an income element coupled with the opportunity to recognize equity type appreciation.

One example is a Canadian income trust structure which is available to issuers in a variety of industries. One disadvantage of the Canadian income trust structure for United States issuers is the requirement to include a Canadian holding company in their corporate structures. In addition, there may be a requirement that residents of Canada own a certain percentage of the securities in accordance with this structure.

Another example of a capital structure is a master limited partnership (“MLP”). MLPs are limited in the United States to certain industries such as natural resources including, for example, oil and gas, pipeline, mining, timber, and the like. This industry limitation prohibits many companies in other industries from utilizing the structure. The market size for MLPs is approximately $50 billion. The MLP structure requires that a significant percentage (e.g., 90% or more) of the investment income generated by the MLP is “qualifying” income derived from processing natural resources.

Still another example of a capital structure is a real estate investment trust (“REIT”). REITs are applicable to issuers in a variety of eligible real estate industries including office property, hotels, health care, apartments, and shopping centers. The market size for REITs is approximately $350 billion. One disadvantage of the REIT structure is its susceptibility to factors affecting the real estate industry. Other common disadvantages are that a significant percentage (e.g., 90% or more) of taxable income generated by the REIT must be distributed to investors, and a significant percentage of the underlying assets of the REIT must be held in the form of real estate assets.

Another example is an income deposit security (“IDS”) structure, which offers a unit including an equity component and a debt component. Unit separation of the equity component from the debt component can be provided after a period of three to six months. The IDS has a debt component with a fixed maturity of only 10 years, with the possibility of two five-year extensions of the fixed maturity period.

Thus, it can be seen that many conventional instruments, securities and capital structures do not provide optimal vehicles for accomplishing the financial objectives of issuers and/or investors.

### SUMMARY

In embodiments of the present invention, a unit capable of being listed on at least one exchange is provided. The unit includes an equity component and a debt component, the equity component being detachable from the debt component; the unit having a significant yield; the equity component comprised of common stock; the debt component having a fixed maturity period of approximately 30 years or less; and, the debt component being puttable back to an issuer after expiration of a certain put period. In various aspects, the certain put period is approximately ten years or less and/or in the range of approximately five years to approximately ten years. In other aspects, the debt component is again puttable back to the issuer after expiration of a second put period, wherein the second put period is at least five years after the certain put period. In still other aspects, the debt component is puttable back to the issuer after at least four put periods prior to maturity of the debt component.

In various embodiments of the present invention, the significant yield is in the range of greater than approximately 5%; the debt component further includes an interest deferral period for the issuer of the unit, the applicability of which may be triggered based upon a condition relating to the issuer (e.g., the issuer's debt to earnings before interest, taxes, depreciation, and amortization (“EBITDA”) ratio relative to a threshold value); the debt component further includes at least one guarantee, which may be provided on a subordinated basis by an operating entity of the issuer of the unit; the debt component is puttable back to the issuer upon failure of the issuer to meet at least one technical covenant; the equity component may include a dividend paid on a quarterly basis; and/or the debt component may include a coupon paid on a quarterly basis.

In other embodiments of the present invention, a capital structure is provided. The capital structure includes an issuer having at least one unit issued to at least one of a unit investor and a shareholder of the issuer; the issued unit capable of being listed on at least one exchange, the issued unit including an equity component and a debt component, the equity component being detachable from the debt component; the unit having a significant yield; the debt component having a fixed maturity period of approximately 30 years or less; the equity component comprised of common stock; and, the shareholder having a holdback equity ownership interest in the issuer of at least approximately 10% of outstanding equity of the issuer.

In various embodiments, the shareholder is a shareholder of the issuer prior to issuance of the issued unit; the shareholder heldback equity ownership interest represents an aggregate interest of a plurality of the shareholders; an original entity is associated with the issuer, wherein the shareholder is a shareholder of the original entity prior to issuance of the issued unit; the shareholder heldback equity ownership interest represents an aggregate interest of a plurality of the shareholders; at least a portion of the heldback equity ownership interest is exchangeable for an amount of the issued unit; the equity component includes a dividend paid on a quarterly basis; and/or the debt component includes a coupon paid on a quarterly basis.

In other embodiments of the present invention, methods for arranging for issuance of a unit are provided. One method embodiment includes the steps of: structuring a unit comprising an equity component and a debt component, the equity component being detachable from the debt component; the unit having a significant yield; the equity component comprised of common stock; the debt component having a fixed maturity period of approximately 30 years or less; the debt component being puttable back to an issuer after expiration of a certain put period; and, arranging for issuance of the structured unit.

In other embodiments of the present invention, a capital structure is provided. The capital structure includes an issuer having at least one unit issued to at least one of a unit investor and a shareholder of the issuer; the issued unit capable of being listed on at least one exchange, the issued unit including an equity component and a debt component, the equity component being detachable from the debt component; the unit having a significant yield; the debt component having a fixed maturity period of approximately 30 years or less; the equity component comprised of common stock; and, a third party debt holder having a held debt interest of at least approximately 10% of issuer debt, wherein the held debt interest is in the form of at least one debt instrument of the issuer including terms substantially similar to terms associated with the debt component, and wherein the issuer debt comprises the at least one debt instrument and the debt component of the issued unit, and wherein the third party debt holder is not the unit investor and is not the shareholder.

In various embodiments, the held debt interest of the third party debt holder represents an aggregate interest of a plurality of the third party debt holders; the substantially similar terms include coupon and maturity period; the coupon is paid on a quarterly basis; the substantially similar terms include interest deferral period, at least one put option, and at least one guarantee; the substantially similar terms include substantially all the terms associated with the debt component except principal amount; the equity component includes a dividend paid on a quarterly basis; and/or the debt component includes a coupon paid on a quarterly basis.

Other embodiments of the present invention will become apparent to those skilled in the art upon review of the following description and figures. It is intended that all such additional embodiments be within the scope of the present invention and be protected by the claims.

### BRIEF DESCRIPTION OF THE FIGURES

FIG. 1 includes a schematic representation of one example of a debt/equity unit provided in accordance with various aspects of the present invention;

FIG. 2 includes a schematic representation of one example of a capital structure provided in accordance with various aspects of the present invention;

FIG. 3 includes a schematic representation of one example of a capital structure provided in accordance with various aspects of the present invention;

FIG. 4 includes an exemplary pricing matrix provided as an example of analysis applicable to the present invention; and,

FIG. 5 includes a schematic diagram illustrating exemplary aspects of various system and computer-readable media embodiments provided in accordance with the present invention.

### DESCRIPTION

As employed in accordance with various embodiments of the present invention discussed herein, an “investor” includes any financial entity, institutional entity, and/or individual entity capable of managing, transacting, maintaining and/or performing one or more financial or investment functions in association with practice of various aspects of the present embodiments. It can be appreciated that the term “investor” can include financial/institutional entities such as, for example and without limitation, hedge funds, mutual funds, family offices, separately managed accounts, limited partnerships, trusts, and/or other entities, institutions and/or accounts which can be structured for application to various aspects of the present invention. As employed in accordance with various embodiments of the present invention discussed herein, an “issuer” includes any financial entity, institutional entity, company, business or other enterprise capable of performing one or more functions in association with practice of various aspects of the present embodiments, including issuing a unit, for example, or establishing a capital structure within the scope of the present invention.

As employed in accordance with various embodiments of the present invention discussed herein, the term “significant yield” which may be used to describe the yield of a bond, for example, is defined as understood by those skilled in the art. In various aspects of practice of the present embodiments, a “significant yield” is a yield, for example and without limitation, in the range of approximately 5% or greater.

As employed in accordance with various embodiments of the present invention discussed herein, the term “low growth” as applied with respect to an issuer of a unit, for example, can be defined as revenue growth of less than a threshold amount for a given time period. In certain aspects of the present embodiments, “low growth” can be considered, for example, less than approximately 5% revenue growth per year for an issuer.

As employed in accordance with various embodiments of the present invention discussed herein, the term “stable” with respect to cash flow of an entity can be considered a cash flow having a low probability of more than a predetermined percentage decline for a given period. In certain aspects of the present invention, “stable” with respect to cash flow of an entity can be considered, for example, a cash flow that demonstrates a high probability of less than an approximately 20% decline from a first year period to a second year period.

Selected examples of entities that may have revenues that can be characterized as “low growth” or that may possess cash flows that can be characterized as “stable” include, without limitation, telephone directory companies, cable companies, incumbent local exchange carriers (ILECs), mature consumer brand companies, railroads, utility companies, and/or other entities suitably structured for application to one or more aspects of the present invention.

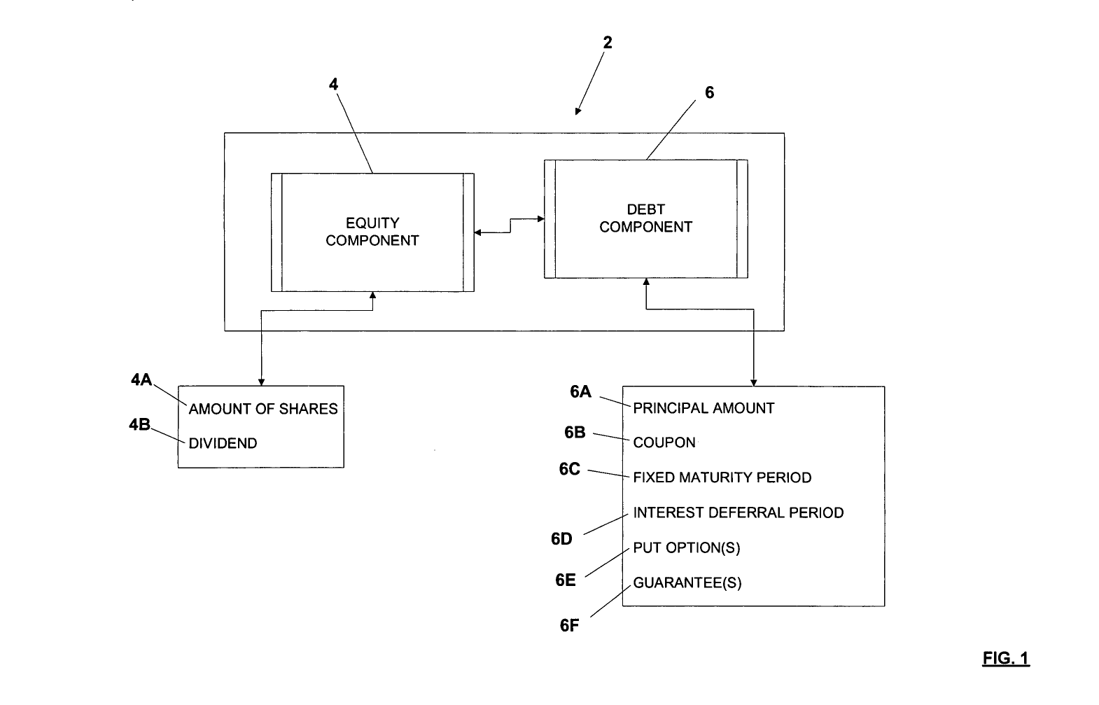

Referring now to FIGS. 1 through 3, exemplary embodiments of the present invention are illustrated including one or more debt/equity units, such as a unit 2, for example, issued by an issuer 102. In one aspect, the unit 2 includes an equity component 4 and a debt component 6. The equity component 4 of the unit 2 may be an equity security of the issuer 102 (e.g., common stock) comprised of an amount of shares 4A. The equity component 4 may entitle the holder to receive a dividend 4B. In one exemplary aspect, selection of the dividend 4B for the equity component 4 may be motivated by the pricing of the unit 2 for promoting its sale, for example, to investors. The dividend 4B may be paid on a quarterly basis, for example, or on another suitable periodic or non-periodic basis. In various aspects, once a number of the equity components 4 associated with the issued unit 2 are detached, an obligation arises for the issuer 102 to seek listing for the detached equity components 4 on a conventional exchange or market (e.g., a listing on the New York Stock Exchange (NYSE)). In one exemplary aspect, once a predetermined percentage amount of detached equity components 4 is in the range of approximately 50% or more of the total issued amount of the equity component 4 of the unit 2, then an obligation arises for management of the issuer 102, for example, to seek listing of the detached equity components 4 on an appropriate exchange. It can be appreciated that such listing may enhance the underlying liquidity of the equity component 4 (e.g., common stock). It can be seen that various embodiments of the present invention may provide securities to investors that are suitable for transactions in retail investment markets and may provide an underlying equity component (e.g., common stock) which is listable on an exchange for securities.

The debt component 6 of the unit 2 may be a debt security (e.g., a note, a bond, or a high yield bond issued in accordance with SEC Rule 144A) having a principal amount 6A. The principal amount 6A and/or the coupon 6B may be set in a manner that is beneficial to the issuer 102 such as, for example, from a credit standpoint, a leverage standpoint, and/or to offset treatment of taxable income of the issuer 102. It can be appreciated that interest on debt may be deductible at the corporate level of an entity where applicable in view of relevant tax laws, regulations, rules and/or policies. In various aspects, the debt component 6 includes a fixed maturity period 6C of approximately 30 years or less. The coupon 6B may be paid on a quarterly basis, for example, or on another suitable periodic or non-periodic basis. It can be appreciated that the length of the fixed maturity period 6C may provide enhanced tax benefits to the issuer 102, in accordance with tax treatment of long-term debt under applicable laws, regulations, rules and/or policies. Other benefits may be realized in the form of enhanced yield on the issued unit 2 due to the use of long-term bonds, for example, with comparatively higher yields.

In other aspects, the debt component 6 may include an interest deferral period 6D. In one exemplary aspect, the interest deferral period 6D is in the range of approximately two years. In various aspects, the interest deferral period 6D is an option for the issuer 102 that is triggered based upon a condition relating to the issuer 102 (e.g., the issuer's 102 debt to EBITDA ratio relative to a threshold value). It can be seen that the interest deferral period 6D offers flexibility to the issuer 102, in the event that adverse financial conditions impact the issuer 102 and interest payments, for example, temporarily cannot be met by the issuer 102 on the debt component 6.

In still other aspects of the debt component 6, one or more put options 6E can be provided for the debt component 6, wherein the debt component 6 is puttable back to the issuer 102 after a certain put period. In certain aspects, the debt component 6 of the issued unit 2 is puttable back to the issuer 102 by unit investors 106, for example, after approximately ten years or less, and/or in the range of approximately five years to approximately ten years. In other aspects, the debt component 6 of the issued unit 2 may be again puttable back to the issuer 102 by the unit investors 106 after expiration of a second put period, wherein the second put period is at least five years after the certain put period. In various aspects, the debt component 6 is puttable back to the issuer 102 after at least four put periods prior to maturity 6C of the debt component 6.

In various aspects, the possibility of exercising a put option 6E may be subject to the failure of the issuer 102 to meet certain predetermined technical covenants or other negotiated terms and/or conditions. One example of a technical covenant is that the ratio of debt of the issuer 102 to the EBITDA of the issuer 102 cannot exceed five. In one example, if the debt to EBITDA ratio exceeds five, then the technical covenant is deemed to have failed, thus raising the possibility of the unit investors 106 to exercise the put option 6E. In various aspects, the debt component 6 of the unit 2 has one or more guarantees 6F. In certain aspects, the debt component 6 can be guaranteed by an operating entity 102B of the issuer 102, on a subordinated basis (e.g., the debt component 6 can be subordinated to other debt of the operating entity 102B such as bank debt, for example, or other senior debt of the operating entity 102B).

The equity component 4 and the debt component 6 may not be separated/detached (e.g., one of the components 4, 6 of the unit 2 may not be transferred to a third party separately from the other component 4, 6 of the unit 2) by the holder for a period of non-detachability such as approximately six months, for example. After expiration of the period of non-detachability, the components 4, 6 can be structured in the unit 2 to become detachable at the option of the holder of the unit 2. It can be appreciated that a suitable period for the non-detachability of the components 4, 6 of the unit 2 may be determined, at least in part, by prevailing objectives, laws, regulations, rules, and/or policies governing the accounting and/or tax treatment of the unit 2 and its components 4, 6.

In certain aspects of the present invention, the yield of the unit 2 is comparatively high with respect to the yields of other types of investments. In one exemplary aspect, the unit 2 can be transacted with a significant yield in the range of approximately 8% to 13%. It can be appreciated that yield-based valuation of the unit 2 may lead to premium valuation for the unit 2 in comparison to traditional capital structures and financial instruments.

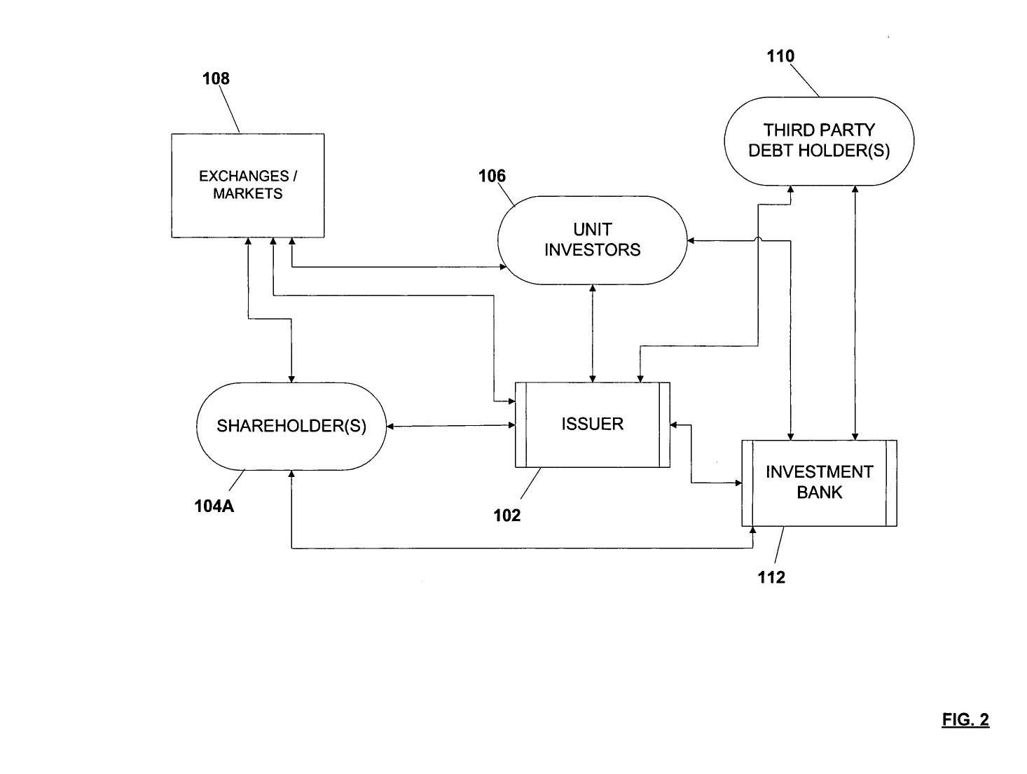

In one embodiment, as shown in FIG. 2, an issuer 102 having shareholder(s) 104A may undertake to issue units 2 to one or more unit investors 106. The units 2 may be listed on at least one exchange/market 108, which may be a United States exchange such as the NYSE or NASDAQ, for example. It can be appreciated that the unit 2 may provide a permanent or substantially permanent capital structure to the issuer 102 and that capital may be raised in the future by the issuer 102 through additional issuance of units 2 to existing and/or new unit investors 106.

After issuance of the units 2 (and related transaction(s)), those shareholder(s) 104A who were and still remain shareholder(s) of the issuer 102 (which may be one or more individuals/entities) should in the aggregate retain/hold a “holdback equity ownership interest” in the issuer 102 (consisting only of equity outside of the issued units 2, not including the equity components 4 of any units 2 that may have been issued to these shareholder(s)) in the range of approximately 10% or more of the outstanding equity of the issuer 102 (including equity existing outside of the issued units 2 as well as the equity components 4 of the issued units 2). It may be appreciated that at least some of the proceeds from issuance of the units 2 may be used to purchase shares from one or more of the shareholders 104A, which shares may then be included as the equity component 4 of the issued units 2. As stated above, the equity ownership interest retained/held by the shareholders 104A after issuance of the units 2 is considered a minimum “holdback” amount with respect to the outstanding equity of the issuer 102. The shareholders 104A may be provided with the option to exchange at least a portion of the heldback equity ownership interest for an amount of the issued unit 2 after a predefined holding period, for example, one year. In one aspect, the equity ownership interest may also be exchanged into a determined amount of the issued unit 2 based upon a fair market value appraisal at the time of the exchange. It can be appreciated that a suitable holdback percentage and/or the exchangeability of the retained/held equity ownership interest may be affected by applicable laws, regulations, rules, and/or policies governing transactions associated with equity of the issuer 102.

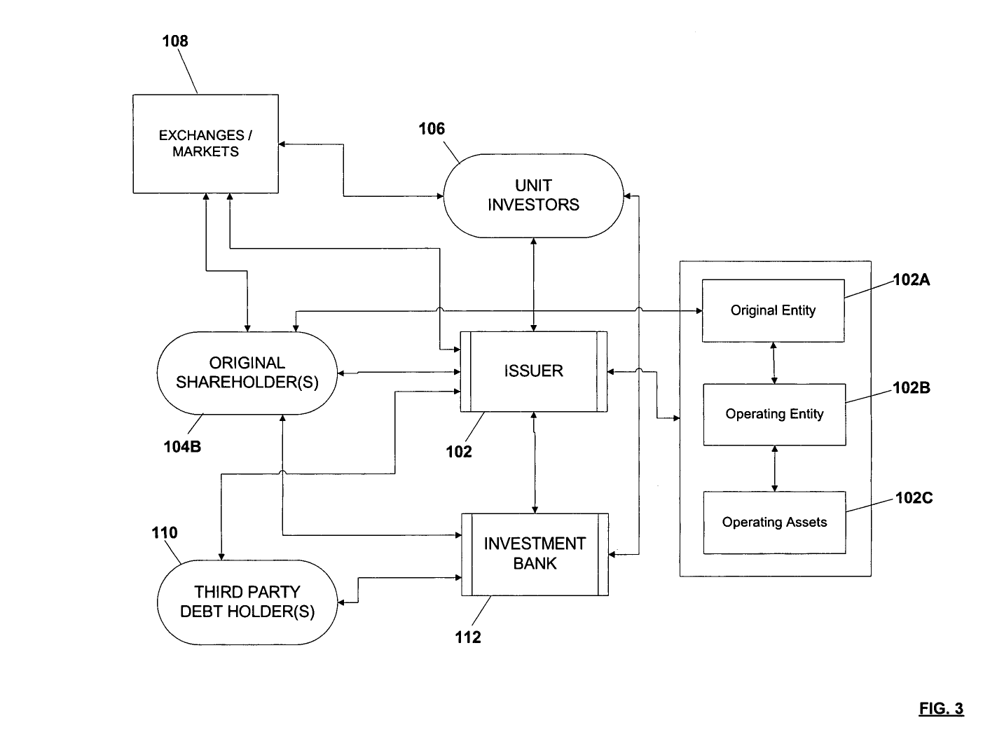

In other embodiments, as shown with reference to FIG. 3, a capital structure includes an original entity 102A, an operating entity 102B and operating assets 102C. Prior to issuance of the units 2, the original entity 102A may be a company with one or more shareholders 104B that desires to revise its capital structure through, for example, creation of the issuer 102 and issuance of units 2 to the unit investors 106. It may be appreciated that a unit investor 106 may also be an original shareholder 104B of the original entity 102A. The operating entity 102B may own/lease operating assets 102C. In the capital structure shown, after issuance of the units 2, the issuer 102 owns a controlling interest in the original entity 102A, which in turn owns a controlling interest in the operating entity 102B. The issuer 102 may acquire such a controlling interest, for example, through purchase of shares from the original shareholder(s) 104B with proceeds from the issuance of units 2. The original entity 102A has a controlling interest in the operating entity 102B. In certain aspects, the operating entity 102B may function as a subsidiary of the issuer 102 providing guarantees for obligations of the issuer 102. In various embodiments, one or more of the issuer 102, the original entity 102A, and the operating entity 102B can be characterized, at least in part, as having low growth and/or a stable cash flow.

After issuance of the unit 2 (and related transaction(s)), those original shareholder(s) 104B of the original entity 102A that now hold shares in the new issuer 102 and may or may not still hold shares in the original entity 102A (such post issuance original shareholders being one or more individuals/entities) should in the aggregate hold a “holdback equity ownership interest” in the issuer 102 (consisting only of equity outside of the issued units 2, not including the equity components 4 of any units 2 that may have been issued to these original shareholder(s)) in the range of approximately 10% or more of the outstanding equity of the issuer 102 (including both equity existing outside of the issued units 2 as well as the equity components 4 of the issued units 2). As stated above, the equity ownership interest held by the original shareholders 104B is considered a minimum “holdback” amount with respect to the outstanding equity of the issuer 102. The original shareholders 104B may be provided with the option to exchange at least a portion of the heldback equity ownership interest for an amount of the issued unit 2, such as after a predefined holding period, for example, one year. In one aspect, the equity ownership interest may also be exchanged into a determined amount of the issued unit 2 based upon a fair market value appraisal at the time of the exchange. It can be appreciated that a suitable holdback percentage and/or the exchangeability of the held equity ownership interest may be affected by applicable laws, regulations, rules, and/or policies governing transactions associated with equity of the issuer 102.

In various embodiments of the present invention, one or more third party debt holders 110 may be associated with the issuer 102 in one or more of the capital structures described herein. The debt holders 110 may hold debt of the issuer 102 in the form of one or more debt instruments (e.g., notes) issued by the issuer 102. In various aspects, the terms of the issued debt instruments (e.g., coupon, maturity period, interest deferral period, put options, guarantees, and/or other terms/conditions) may be structured to be substantially similar to the terms of embodiments of the debt component 6 described herein. In various aspects, the third party debt holders 110 are neither the unit investors 106 nor the shareholders 104A, 104B.

Prior to issuance of the units 2 (and related transaction(s)), the third party debt holders 110 generally do not hold any debt or equity of the issuer 102 or the original entity 102A. After issuance of the unit 2 (and related transaction(s)), the debt holder(s) 110 (which may be one or more individuals/entities) should in the aggregate have a “held debt interest” (consisting only of debt outside of the issued units 2 having terms substantially similar to terms of the debt component 6 of the issued units 2) in the range of approximately 10% or more of the debt of the issuer 102 (including debt existing outside of the issued units 2 having terms substantially similar to terms of the debt component 6 of the issued units 2, as well as the debt components 6 of the issued units 2). It can be appreciated that a suitable held debt percentage may be affected by applicable laws, regulations, rules, and/or policies governing transactions associated with debt of the issuer 102.

In other aspects of the present invention, a financial institution such as an investment bank 112, for example, as shown in FIGS. 2 and 3, can be operatively associated between/among the issuer 102, the shareholders 104A, 104B, the unit investors 106, and/or the third party debt holders 110. In various aspects, the investment bank 112 can structure a transaction that includes issuance of a unit 2 as described hereinabove. According to various embodiments, the investment bank 112 may price the unit 2 for an offering using pricing models, data regarding similarly structured transactions, feedback from investors, and/or other factors. In addition, the investment bank 112 may market the unit 2 to potential investors, underwrite the issuance of the unit 2, and/or arrange various aspects of the transaction structure. In one aspect, the investment bank 112 structures a transaction between the issuer 102 and one or more of the third party debt holders 110, for example.

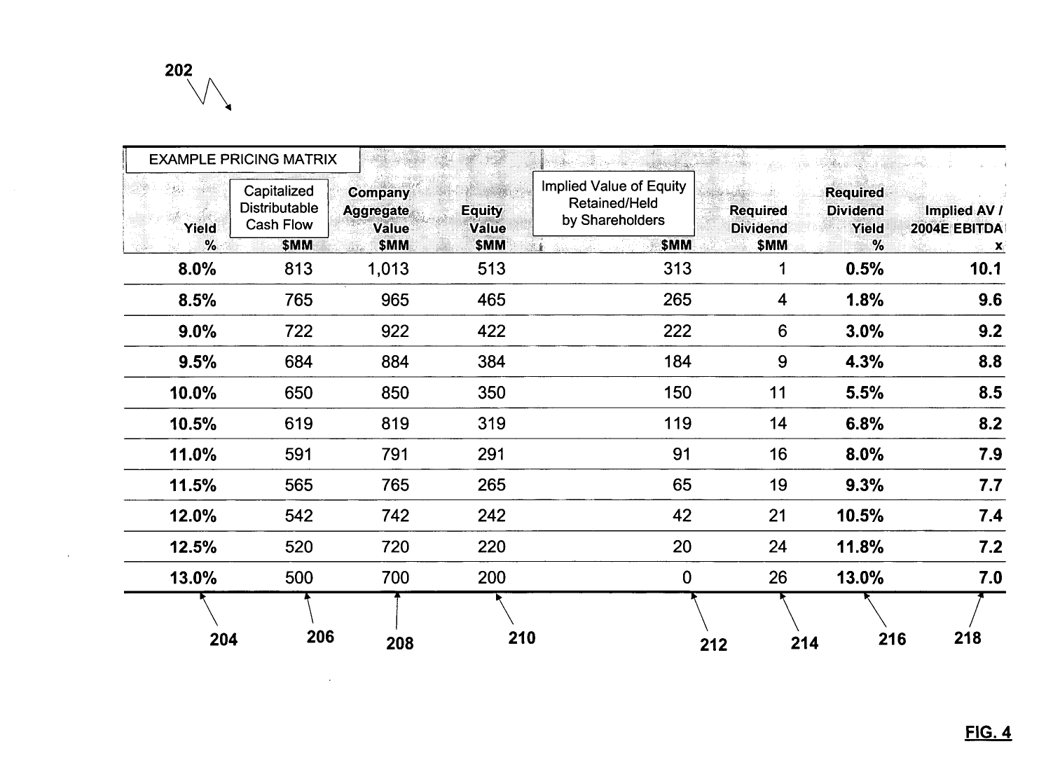

Referring now to FIG. 4, various aspects of the present invention are illustrated through an exemplary pricing matrix 202, as shown. The following assumptions are made for purposes of explaining the pricing matrix 202: an offering size for an issued amount of units 2 is $500 MM, which includes $300 MM of issuer 102 notes with a 13% coupon (debt component 6) and $200 MM of issuer common stock (equity component 4); and, the issuer 102 has $200 MM of outstanding senior debt with an interest rate of 5%. Determination of the offering size ($500 MM) and the sizes of the components 4, 6 may be driven, at least in part, by tax considerations, estimated market size for the units 2, and cash flow profile of the issuer 102. It is also assumed that the issuer 102 has an annual distributable cash flow of $65 MM that may be calculated as follows: EBITDA of $100 MM less capital expenditures of $10 MM, less senior debt interest expense of $10 MM, less taxes of $15 MM.

Column 204 shows various yields for the issued units 2 ranging from 8% to 13%. For convenience, the data for a 10% yield are discussed hereinafter. Column 206 shows an amount for the capitalized distributable cash flow of the issued units 2 ($650 MM). The capitalized distributable cash flow can be calculated by capitalizing the distributable cash flow ($65 MM) at the yield of 10%. The capitalized distributable cash flow represents the maximum potential offering size for the issued units 2, such as in the event that the equity component 4 of the issued units 2 represents all the equity of the issuer 102. Column 208 shows the company aggregate value ($850 MM) calculated as the sum of the senior debt ($200 MM) and the capitalized distributable cash flow of the issued units ($650 MM). For purposes of this example, all outstanding debt of the issuer 102 may be considered to be represented by the sum of the senior debt ($200 MM) and the debt component 6 ($300 MM) of the issued unit 2. Column 210 shows the equity value of the issuer 102 ($350 MM), which can be calculated as the difference between the company aggregate value ($850 MM) and the sum of the amount attributable to the debt component 6 of the issued units ($300 MM) and the senior debt ($200 MM).

Column 212 shows the implied value of the equity ($150 MM) that is either held by the shareholders 104A or the original shareholders 104B, which can be calculated as the difference between the equity value of the issuer 102 ($350 MM) and the equity component 4 of the issued units 2 ($200 MM). Column 214 shows a required dividend ($11 MM), which can be calculated as the dividend amount needed to obtain the overall yield (10%) on the issued units 2. In the present example, a 10% yield on a $500 MM offering size requires $50 MM of interest and dividends. In particular, there is a $39 MM interest component derived from the 13% coupon on the $300 MM debt component 6 and, therefore, an $11 MM required dividend component. Column 216 shows a required dividend yield percentage (5.5%), which can be calculated as the required dividend ($11 MM) as a percentage of the equity component 4 ($200 MM) of the issued units 2. In addition, a ratio of the company aggregate value ($850 MM) to the EBITDA value ($100 MM) can be calculated as 8.5, as shown in column 218. It can be appreciated that the pricing matrix 202, or substantially similar versions of the pricing matrix 202, can be employed by the issuer 102 or the investment bank 112, for example, to structure the unit 2 and/or another transaction involving the unit 2.

In accordance with the embodiments of FIG. 3 and the examples of FIG. 4, it can be appreciated that issuance of the units 2 in connection with raising additional senior debt (e.g., bank debt) provides certain proceeds to the issuer 102 and to the original shareholders 104B of the issuer 102. The proceeds to the issuer 102 for issuance of the units 2 include the offering proceeds of $500 MM (assuming no expenses). The issuer 102 also raises an additional $200 MM (assuming no expenses) in senior debt through the original entity 102A and/or the operating entity 102B. The sum of proceeds raised through issuance of the units 2 ($500 MM) and issuance of senior debt ($200 MM) represents total proceeds of $700 MM. The issuer 102 then applies the total proceeds ($700 MM) to purchase approximately 57.1% of the shares owned by the original shareholders 104B. The percentage of shares purchased from the original shareholders 104B by the issuer 102 (57.1%) is calculated as the equity component 4 of the issued units 2 ($200 MM) divided by the equity value of the issuer 102 shown in column 210 ($350 MM). The original shareholders 104B then receive $700 MM in cash and hold an equity ownership interest of 42.9% in the issuer 102.

It can be seen that the held equity ownership percentage is computed as the equity outside of the issued unit 2 ($150 MM) divided by the total equity value of the issuer 102 ($350 MM), which total equity value ($350 MM) includes both equity associated with the equity component 4 of the issued unit 2 ($200 MM) and equity outside of the issued unit 2 ($150 MM). It can be seen, therefore, that the numerator for the computation of the held equity ownership interest includes only the equity outside of the issued unit 2 ($150 MM).

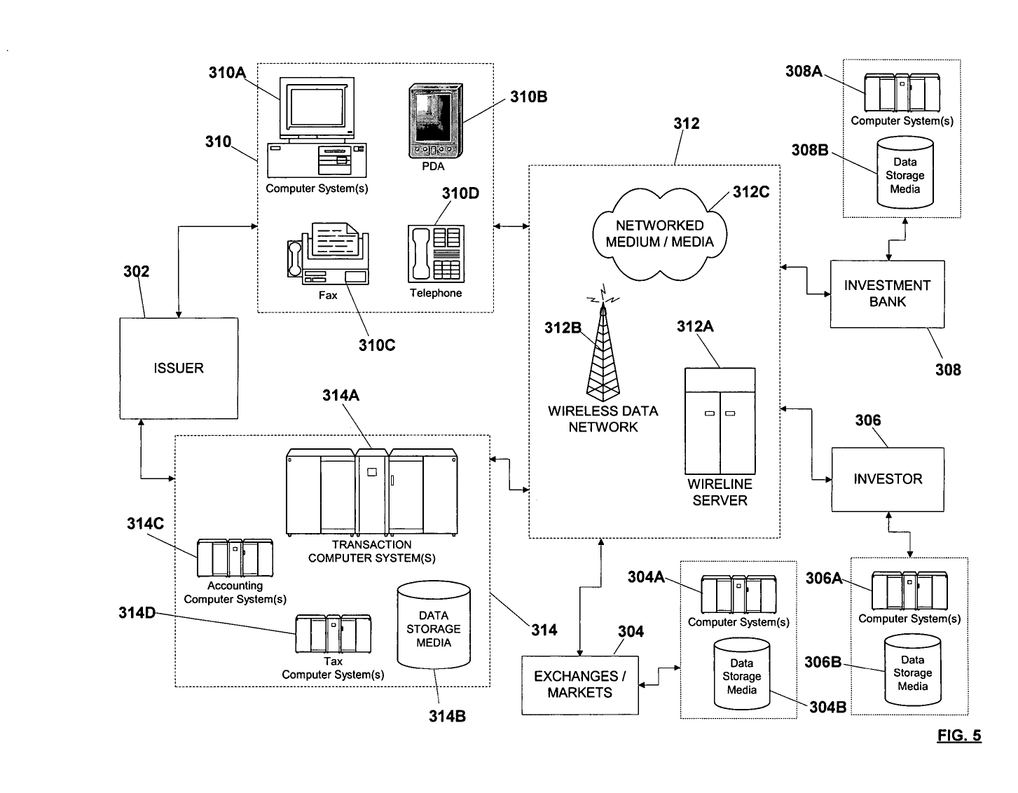

Referring now to FIG. 5, one illustrative system embodiment is provided in accordance with the practice of various embodiments of the present invention. As shown, one or more issuers 302, for example, can communicate and/or exchange data with one or more exchanges/markets 304 (e.g., the NYSE or the NASDAQ), one or more investors 306, and/or one or more investment banks 308. In certain aspects, the issuer 302 may be operatively associated with one or more communications devices 310 such as, for example and without limitation, a computer system 310A, a personal digital assistant 310B, a fax machine 310C, and/or a telephone 310D (e.g., a wireline telephone, a wireless telephone, a pager, and the like), and/or other like communication devices. The communication devices 310 permit the issuer 302, the exchanges/markets 304, the investor 306, and/or the investment bank 308 to communicate between/among each other through one or more communication media 312, such as by use of electronic mail communication through one or more computer systems, for example. The communication media 312 may include, for example and without limitation, wireline communication means such as a wireline server 312A, a wireless data network 312B, and/or a connection through a networked medium or media 312C (e.g., the Internet, an extranet, an intranet, a wide area network (WAN), and/or a local area network (LAN)).

In addition, the issuer 302 (as well as any one or more of the exchanges/markets 304, the investor 306, and/or the investment bank 308) may be operatively associated with one or more data processing/storage devices such as data processing/storage devices 314. The issuer 302 may be operatively associated with one or more transaction computer system(s) 314A, for example, and/or one or more data storage media 314B that can receive, store, analyze and/or otherwise process data and other information in association with communications that occur between/among the issuer 302, the exchanges/markets 304, the investor 306, and/or the investment bank 308. The transaction computer systems 314A may be employed to execute a pricing matrix in accordance with the present invention, for example, such as on a spreadsheet software program, for example. In various aspects, the issuer 302 may be operatively associated, for example, with one or more accounting computer systems 314C and/or one or more tax computer systems 314D. The accounting/tax computer systems 314C, 314D may be configured for receiving, storing, and/or processing data associated with one or more aspects of the units/transactions of the present invention, for example.

In various aspects, the exchanges/markets 304 may be operatively associated with one or more computer systems 304A and/or one or more data storage media 304B. In other aspects, the investor 306 may be operatively associated with one or more computer systems 306A and/or one or more data storage media 306B. In still other aspects, the investment bank 308 may be operatively associated with one or more computer systems 308A and/or one or more data storage media 308B. It can be appreciated that one or more of the computer systems 304A, 306A, 308A, 314A, 314C, 314D and one or more of the data storage media 304B, 306B, 308B, 314B can be employed to communicate, store, analyze, and/or otherwise process data related to financial transactions occurring between and/or among the issuer 302, the exchanges/markets 304, the investor 306, and/or the investment bank 308.

The benefits of the present embodiments are readily apparent to those skilled in the art. Various aspects of the present embodiments provide units, capital structures, strategies, methods, systems, computer-readable media, and/or financial products including a significant yield unit. It can be seen that various aspects of the present embodiments may offer attractive benefits in the form of enhanced tax treatment of investments; maximizing offering size, float and liquidity of investments; and/or issuance of equity or debt that may have otherwise been difficult for a particular type of issuer to incorporate into an issued unit by using conventional investment strategies.

The term “computer-readable medium” is defined herein as understood by those skilled in the art. It can be appreciated, for example, that method steps described herein may be performed, in certain embodiments, using instructions stored on a computer-readable medium or media that direct a computer system to perform the method steps. A computer-readable medium can include, for example and without limitation, memory devices such as diskettes, compact discs of both read-only and writeable varieties, digital versatile discs (DVD), optical disk drives, and hard disk drives. A computer-readable medium can also include memory storage that can be physical, virtual, permanent, temporary, semi-permanent and/or semi-temporary. A computer-readable medium can further include one or more data signals transmitted on one or more carrier waves.

As used herein, a “computer” or “computer system” may be, for example and without limitation, either alone or in combination, a personal computer (PC), server-based computer, server, main frame, microcomputer, minicomputer, laptop, personal data assistant (PDA), cellular phone, pager, processor, including wireless and/or wireline varieties thereof, and/or any other computerized device capable of configuration for processing data for either standalone application or over a networked medium or media. Computers and computer systems disclosed herein can include memory for storing certain software applications used in obtaining, processing, storing and/or communicating data. It can be appreciated that such memory can be internal or external, remote or local, with respect to its operatively associated computer or computer system. The memory can also include any means for storing software, including a hard disk, an optical disk, floppy disk, ROM (read only memory), RAM (random access memory), PROM (programmable ROM), EEPROM (extended erasable PROM), and other suitable computer-readable media.

It is to be understood that the figures and descriptions of embodiments of the present invention have been simplified to illustrate elements that are relevant for a clear understanding of the present invention, while eliminating, for purposes of clarity, other elements. Those of ordinary skill in the art will recognize, however, that these and other elements may be desirable for practice of various aspects of the present invention. However, because such elements are well known in the art, and because they do not facilitate a better understanding of the present invention, a discussion of such elements is not provided herein.

It can be appreciated that, in various embodiments disclosed herein, a single element can be replaced by multiple elements, and multiple elements replaced by a single element, to perform a given function or functions. Except where such substitution would not be operative to practice the present invention, such substitution is within the scope of the present invention.

Examples presented herein, including operational examples, are intended to illustrate potential implementations of the present invention. It can be appreciated that such examples are intended primarily for purposes of illustration. No particular aspect or aspects of the examples described herein are intended to limit the scope of the present invention.

It should be appreciated that figures presented herein are intended for illustrative purposes and are not intended as construction drawings. Omitted details and modifications or alternative embodiments are within the purview of persons of ordinary skill in the art. Furthermore, whereas particular embodiments of the invention have been described herein for the purpose of illustrating the invention and not for the purpose of limiting the same, it will be appreciated by those of ordinary skill in the art that numerous variations of the details, materials and arrangement of parts/elements/steps/functions may be made within the principle and scope of the invention without departing from the invention as described in the claims.

1. A unit capable of being listed on at least one exchange, said unit comprising:
an equity component and a debt component, said equity component being detachable from said debt component;
said unit having a significant yield;
said equity component comprised of common stock;
said debt component having a fixed maturity period of approximately 30 years or less; and,
said debt component being puttable back to an issuer after expiration of a certain put period.

2. The unit of claim 1, wherein said certain put period is approximately ten years or less.

3. The unit of claim 2, wherein said certain put period is in the range of approximately five years to approximately ten years.

4. The unit of claim 2, further comprising said debt component being again puttable back to said issuer after expiration of a second put period, wherein said second put period is at least five years after said certain put period.

5. The unit of claim 4, further comprising said debt component being puttable back to said issuer after at least four put periods prior to maturity of said debt component.

6. The unit of claim 1, wherein said significant yield is in the range of greater than approximately 5%.

7. The unit of claim 1, wherein said debt component further includes an interest deferral period for said issuer of said unit, wherein said interest deferral period is triggered based upon a condition relating to said issuer.

8. The unit of claim 1, wherein said debt component further includes at least one guarantee.

9. The unit of claim 8, wherein said guarantee is provided on a subordinated basis by an operating entity of said issuer of said unit.

10. The unit of claim 1, further comprising said debt component being puttable back to said issuer upon failure of said issuer to meet at least one technical covenant.

11. The unit of claim 1, further comprising said equity component including a dividend paid on a quarterly basis.

12. The unit of claim 1, further comprising said debt component including a coupon paid on a quarterly basis.

13. A capital structure, comprising:
an issuer having at least one unit issued to at least one of a unit investor and a shareholder of said issuer;
said issued unit capable of being listed on at least one exchange, said issued unit including an equity component and a debt component, said equity component being detachable from said debt component; said unit having a significant yield; said debt component having a fixed maturity period of approximately 30 years or less; said equity component comprised of common stock; and, said shareholder having a holdback equity ownership interest in said issuer of at least approximately 10% of outstanding equity of said issuer.

14. The capital structure of claim 13, wherein said shareholder is a shareholder of said issuer prior to issuance of said issued unit.

15. The capital structure of claim 14, wherein said shareholder heldback equity ownership interest represents an aggregate interest of a plurality of said shareholders.

16. The capital structure of claim 13, further comprising an original entity associated with said issuer, wherein said shareholder is a shareholder of said original entity prior to issuance of said issued unit.

17. The capital structure of claim 16, wherein said shareholder heldback equity ownership interest represents an aggregate interest of a plurality of said shareholders.

18. The capital structure of claim 13, wherein at least a portion of said heldback equity ownership interest is exchangeable for an amount of said issued unit.

19. The capital structure of claim 13, wherein said equity component includes a dividend paid on a quarterly basis.

20. The capital structure of claim 13, wherein said debt component includes a coupon paid on a quarterly basis.

21. A method for arranging for issuance of a unit, said method comprising the steps of:
structuring a unit comprising an equity component and a debt component, said equity component being detachable from said debt component; said unit having a significant yield; said equity component comprised of common stock; said debt component having a fixed maturity period of approximately 30 years or less; said debt component being puttable back to an issuer after expiration of a certain put period; and,
arranging for issuance of said structured unit.

22. A capital structure, comprising:
an issuer having at least one unit issued to at least one of a unit investor and a shareholder of said issuer;
said issued unit capable of being listed on at least one exchange, said issued unit including an equity component and a debt component, said equity component being detachable from said debt component; said unit having a significant yield; said debt component having a fixed maturity period of approximately 30 years or less; said equity component comprised of common stock; and,
a third party debt holder having a held debt interest of at least approximately 10% of issuer debt, wherein said held debt interest is in the form of at least one debt instrument of said issuer including terms substantially similar to terms associated with said debt component, and wherein said issuer debt comprises said at least one debt instrument and said debt component of said issued unit, and wherein said third party debt holder is not said unit investor and is not said shareholder.

23. The capital structure of claim 22, wherein said held debt interest of said third party debt holder represents an aggregate interest of a plurality of said third party debt holders.

24. The capital structure of claim 22, wherein said substantially similar terms include coupon and maturity period.

25. The capital structure of claim 24, wherein said coupon is paid on a quarterly basis.

26. The capital structure of claim 22, wherein said substantially similar terms include interest deferral period, at least one put option, and at least one guarantee.

27. The capital structure of claim 22, wherein said substantially similar terms include substantially all said terms associated with said debt component except principal amount.

28. The capital structure of claim 22, wherein said equity component includes a dividend paid on a quarterly basis.

29. The capital structure of claim 22, wherein said debt component includes a coupon paid on a quarterly basis.
